(19) United States
(12) Patent Application Publication
(10) Pub. No.: US 2022/0027823 A1
(43) Pub. Date: Jan. 27, 2022

(54) MOBILE VEHICLE INSPECTION SYSTEM

(71) Applicant: CarDr.com, Hinsdale, IL (US)

(72) Inventor: Parminder Singh, San Juan, PR (US)

(21) Appl. No.: 16/935,138

(22) Filed: Jul. 21, 2020

(51) Int. Cl. G06Q 10/06; G06Q 10/10; G06Q 10/00; G06Q 30/02; G06Q 30/00; G06N 20/00; G06K 7/14; G07C 5/08

(52) U.S. Cl. CPC G06Q 10/06316; G06Q 10/10; G06Q 10/06311; G06Q 10/20; G07C 5/0808; G06Q 30/0185; G06N 20/00; G06K 7/1413; G06Q 30/0278

(57) ABSTRACT

A system for generating a dynamic and customized inspection checklist for diagnosing a vehicle includes a smart mobile computing device, including an input device, an output device and a mobile inspection module, configured to: identify a type of vehicle based at least in part on obtaining at least one of a VIN, a model, or a make of the vehicle; and connect with at least one sensor associated with a plurality of vehicle components installed on the vehicle to obtain, in real-time, at least one parameter associated with each vehicle component; and a server communicatively coupled to the smart mobile computing device, configured to: generate a dynamic inspection checklist customized based on the parameters, the dynamic inspection checklist including at least one identified and recommended inspection task; and retrieve, in response to establishing a connection with at least one of an OBD or the sensors, the parameters.

### BACKGROUND OF THE INVENTION

### 1. Field of the Invention

The present disclosure relates to systems for inspecting items including, but not limited to, motor vehicles, in particular, smart mobile computing devices guided and/or enabled systems, methods, techniques, services and user interfaces for generating a dynamic and customized inspection checklist for inspections of a vehicle.

### 2. Description of the Related Art

In modern commercial transactions, it is often desirable to examine goods or other articles carefully to ascertain their condition. New articles rolling off an assembly line are often inspected to ensure that they are saleable and do not suffer from any major defects. Inspections become especially important in the used goods market; it is often desirable to inspect such used goods to determine whether they have been damaged during use and/or to ascertain their current value.

Vehicle inspections are especially important for “high value” used cars, motorcycles, commercial vehicles such as trucks and RV's. A used vehicle that has suffered damage through poor driving, hard use or been subject to an accident is not as valuable as a vehicle that has been lightly used, well maintained and never been subject to any accidents. Used car buyers are often warned to obtain a complete inspection before purchase to minimize a risk of the used vehicle having hidden defects or damages.

Likewise, those dealing with a large used item inventory need reliable vehicle inspections. In the past, inspections were generally performed manually using pre-printed forms. The more modern form of inspections is a web upload version to upload the status memory checklist which inspectors follow, and then go back to a computer at the end of the day to upload the pictures and the web-form such as or similar to an “inspection web form”. However, the web upload version tends to result in the upload of the inspection data at the end of the day. It is likely that the inspector has performed numerous inspections during the day, and at the upload time, any ability to jog his/her memory might have faded by the passage of time and/or fatigue, and that may cause the inspector to forget to include all of the inspection results he/she has performed. This may also result in uploading incomplete results, whereby at least one inspections may be missed for any number of inspections. Further, the printed form for web upload version generally does not aid the inspector with performing the inspections, e.g., it does not give a guidance or list of items to be inspected for a full and complete inspection report. Thus, the inspector may miss some key details during the inspection. In addition, unlike a factory setting, where inspections can be performed in a regular, consistent manner, inspections on used products based on a printed form can result in inconsistent inspections, particularly when such inspections are being carried out around the country or around the world.

Inspections can also be critical in other, non-purchasing situations. For example, when products are brought in for repairs, the lack of accurate inspections can result in potential problems. In some instances, a customer may be unaware of issues like dings and scratches on his/her vehicle until he/she comes to pick it up after service. Suddenly, the customer sees a damage element that was never noticed before and immediately assumes that the repair shop or dealership is responsible. If the inspector neglected to inspect the vehicle at time of drop off, or if the inspector overlooked the damage, the dealership may be left with no choice but to fix the damage at no charge while the customer drives around in a loaner car. This process becomes increasingly expensive; the company's customer service index suffers, and one of the most unfavorable results is a disappointed or even angry customer.

It is believed that average dealerships, for example, can spend from $3,000 to $30,000 per month repairing lot damage. Of that amount, at least half may be due to the failure to inspect a new car, service or loaner car at the time they are dropped off or picked up, or lot personnel overlooking damage during inspection, and/or unsubstantiated claims by customers. Documentation of rental unit body damage can be also an expensive problem for car rental companies.

Motorized vehicles, such as cars, trucks, boats, etc., have many components and systems that function alone, or in coordination with other components and systems, to allow proper operation of the vehicle. Examples of such components and systems may include, but not limited to, drive systems, brake systems, emissions systems, transmission systems, belts, hoses, fluid levels, tires, etc. In order to ensure that a proper operation of the vehicle is maintained, vehicle inspections and repairs are typically recommended by the vehicle manufacturer at selected intervals in order to check the operation of the vehicle's many components and systems.

In the past, inspections were generally performed manually using preprinted forms. The inspector would work from a form or check list on a clipboard as he or she visually inspected the item. Defects should be noted on the form. Sometimes, such forms might include schematic illustrations (e.g., line drawings) of the item being inspected so the inspector could note location and type of damage. Such forms could be mailed or transmitted electronically by facsimile. Damage assessments could be made by comparing information noted on the form with standard damage assessment information. In the case of motor vehicles, for example, the inspector or other person could consult a valuation guide, e.g., the Kelley Blue Book or other source, to determine the fair market value of the vehicle based on the condition of the vehicle, the options installed and other factors.

In order to assist in the inspection and repair process, vehicle inspection forms, lists, or checklists are often utilized. An inspection list provides an inventory of components to check during a vehicle inspection. In some examples, such a list may be generated by a vehicle manufacturer. In another example, inspection lists may be generated by individual automobile repair facilities. In this manner, a technician or mechanic can be advised of a variety of systems and/or components to inspect and/or repair.

Preprinted forms may be acceptable in some situations for some types of needs and applications, but can be inconvenient or inefficient in most other contexts. Suppose, for example, that an inspection service conducts inspections for a number of different clients each having different inspection standards. In the motor vehicle context, one client might want to know about every scratch on the vehicle paint, whereas another client might only care about scratches that are longer than three inches. If an inspection service conducted inspections for a large number of different clients and types of motor vehicles, the number and variety of forms would soon get out of hand. If one adds additional challenges such as a large number of geographically-disparate inspectors, clients who want the ability to dynamically change their inspection requirements and/or procedures, and the need to rapidly communicate inspection reports and other results to different locations, it will become readily apparent that using preprinted forms to collect inspection data with any consistency becomes impractical, if not impossible.

Some in the past have attempted to use computers and computer systems to gather inspection information. Various systems and techniques have been developed. Unfortunately, these inspection checklists function as “one-size-fits-all” and are used for multiple makes, models, years, etc. of vehicles, each with different drivers and different repair histories. Thus, these generic inspection checklists can potentially waste the vehicle owner's time and resources, since they may result in inspection of systems that are without problems, while missing other unlisted systems that may need repair. Additionally, certain vehicles may have unique repair needs that are not included on generic inspection checklists.

Accordingly, there is a need for systems and methods that improve the vehicle inspection process to provide consistent and reliable inspections so that the components that are most likely to need service or repair are examined thoroughly, while other components may be more quickly examined or not examined at all. However, further improvements are possible and desirable. More particularly, there is a need for smart mobile computing device guided and/or enabled systems, methods, techniques, services and user interfaces for generating a dynamic and customized inspection checklist for inspections of a vehicle.

### SUMMARY OF THE INVENTION

The present disclosure provides novel smart mobile computing device-assisted systems, methods, techniques, services and user interfaces for generating a dynamic and customized inspection checklist for inspections of a vehicle in real-time. The smart mobile computing device-assisted systems, methods, techniques, services and user interfaces in accordance with the present disclosure may provide a real-time, step-by-step guided inspections in accordance with the dynamic and customized inspection checklist for inspections of a vehicle. The guided inspections may require the inspector to follow the step-by-step inspection with real-time data uploaded to a server for every step since the inspector may perform at least one tests as per the dynamic and customized checklist of tests and submit the responses with images of any anomalies or faults with each test.

The smart mobile computing device-assisted systems, methods, techniques, services and user interfaces in accordance with the present disclosure may scan a vehicle identification number (VIN) on a windshield and/or on the door frame of the vehicle in order to obtain the vehicle information from vehicle databases. The smart mobile computing device-assisted systems, methods, techniques, services and user interfaces may connect the information device to On-Board Diagnostics (OBD) of the vehicle (or similar connection point) in order to run performance tests. The wealth of information that may be obtained from the OBD may be extremely thorough and analogous to a scenario such as where a magnetic resonance imaging (MRI) was performed on the vehicle while driving it. Such OBD parameters scanned may include, but are not limited to: Engine load, Engine revolutions per minute (RPM), vehicle speed, throttle position, coolant temperature, fuel trim, fuel pressure, fuel system status, intake manifold pressure, intake air temperature, mass air flow (MAF) air flow rate, air status, oxygen sensor status, runtime since engine start distance with a malfunction indicator lamp (MIL) on, fuel tank level input, system vapor pressure, absolute load, value, hybrid battery pack life, engine oil temperature, engine fuel rate, torque, VIN, manufacturer supported Parameter's and various diagnostic trouble codes (DTCs)—collectively referred to as “PID's” (parameter identifications). A state-of-the art artificial intelligence (AI), neural network, and Machine Learning (ML) techniques of the smart mobile computing device-assisted systems, methods, techniques, services and user interfaces may be utilized in order to understand various aspects of vehicle performance from the information obtained from the OBD port.

Personnel for an inspection company (e.g., CarDr.com) or a seller or buyer entity (e.g., retail or wholesale car seller/buyer), such as an inspector, may use the smart mobile computing device or be provided with a touch based portable computing device like a tablet capable of performing the functionalities of the smart mobile computing device in accordance with the present disclosure. The inspector may follow the steps as guided by a mobile application for generating and providing a dynamic and customized inspection checklist for inspections of a vehicle in real-time, and input the conditions of the vehicle (e.g., “Good”, “Bad”, “N/A” and “Comment” and other extensive condition facts etc.) using a touch screen and sensors (e.g., camera, microphone, or other detecting devices) of the smart mobile computing device in real-time.

A mobile inspection application may be a software application, for example a proprietary app (e.g., CarDr.com APP), running on the smart mobile computing device. The smart mobile computing device using the mobile application may scan the VIN number, e.g., from the windshield, connect to the OBD, and retrieve live, e.g., more than 200 different OBD parameters. Using some or all of these OBD parameters, each including parameter identification (PID), the present disclosure may operate as if it is putting finger on the vehicle's pulse, read its heartbeat, and see how its vitals change during a test drive. A used car inspection report may include information such as coolant and engine oil temperature, engine load, and throttle position, where each of the information is translated into a data point. With these data points, one may be able to discern, e.g., how hard a vehicle may have to work at getting up to speed, if it needs help staying cool, or what types of repairs it may need (whether immediately or in the future).

The smart mobile computing device assisted-systems or smart mobile computing device guided and/or enabled systems, methods, techniques, services and user interfaces in accordance with the present disclosure may use a comprehensive checklist to label each of checks to be made by the inspector on, e.g., a touch screen of the smart mobile computing device in order to generate a comprehensive vehicle health score. The smart mobile computing device assisted-systems or guided and/or enabled systems, methods, techniques, services and user interfaces may dynamically schedule inspections based on a time-slot based availability of the inspector and location of the vehicle and/or inspector.

Accordingly, the present disclosure provides novel smart mobile computing device-assisted systems, methods, techniques, services and user interfaces for generating a dynamic and customized inspection checklist for inspections of a vehicle in real-time so as to provide a guided inspection of a vehicle, thereby reducing any human error (e.g., forgetting to run a necessary check, forgetting to input a test result, etc.) and thus providing accurate, reliable, and comprehensive inspection results. Further, the guided inspections may also decrease, if not eliminate, disputes over the quality of the vehicle or inspection results related to the vehicle, thus saving costs and/or expenses that may arise from such disputes.

These benefits may be achieved in accordance with the present disclosure by providing a system for generating a dynamic and customized inspection checklist for diagnosing a vehicle. The system may include a smart mobile computing device, including at least one input device, at least one output device and a mobile inspection module, and a server communicatively coupled to the smart mobile computing device. The smart mobile computing device may be configured to: identify a type of vehicle based at least in part on obtaining at least one of a vehicle identification number (VIN), a model of the vehicle, or a make of the vehicle; and connect with at least one sensor associated with a plurality of vehicle components installed on the vehicle to obtain, in real-time, at least one parameter associated with each of the plurality of vehicle components. The server may be configured to: generate a dynamic inspection checklist customized based on the obtained at least one parameter, the customized dynamic inspection checklist including at least one identified and recommended inspection task for an inspector; and retrieve, at least in response to establishing a connection with at least one of an on-board diagnostics (OBD) of the vehicle or the at least one sensor, the obtained at least one parameter associated with each of the plurality of vehicle components installed on the vehicle.

In some examples, the smart mobile computing device may be configured to retrieve historical information of the vehicle based on the VIN.

In some examples, a server may be configured to determine the VIN based on a camera scanning a door frame or windshield or by connecting to the on-board diagnostics (OBD).

In some examples, the smart mobile computing device is configured to obtain the model of the vehicle by manually inputting a model information of the vehicle into the smart mobile computing device by the inspector, the model information comprising a model number and a model year of the vehicle.

In some examples, the smart mobile computing device is configured to obtain the make of the vehicle by manually inputting a make information of the vehicle into the smart mobile computing device by the inspector, the make information comprising a brand name of vehicle manufacture.

In some examples, the smart mobile computing device may be configured to guide the inspector to perform a guided test sequentially recommended based on the dynamic inspection checklist.

In some examples, the smart mobile computing device may be configured to receive at least one input from the inspector while performing a guided inspection of the vehicle.

In some examples, the server may be configured to generate different types of labels based on at least one pre-determined label to receive at least one inputs provided by the inspector.

In some examples, the server may be configured to generate at least one profile of the vehicle based on at least one input associated with inspection data received from the inspector in response to a user interface presented in accordance with the dynamic inspection checklist.

In some examples, the smart mobile computing device may be configured to receive at least one input associated with inspection data via the at least one input device in response to a user interface presented in accordance with the dynamic inspection checklist.

In some examples, the smart mobile computing device, in an established connection with the OBD of the vehicle, may be configured to perform the at least one identified and recommended inspection task and display at least one labels to receive facts associated with a plurality of components or performance of the vehicle based on the at least one identified and recommended inspection task, where the at least one identified and recommended inspection task may include an identified and recommended revolutions per minute (RPM) test.

In some examples, the smart mobile computing device in an established connection with the OBD of the vehicle may be configured to perform the at least one identified and recommended inspection task and display at least one label to receive fact associated with a plurality of components or performance of the vehicle based on the at least one identified and recommended inspection task, where the at least one identified and recommended inspection task may include an identified and recommended driving test of predetermined speeds.

In some examples, the smart mobile computing device in an established connection with the OBD of the vehicle is configured to perform the at least one identified and recommended inspection task and display at least one labels to receive fact associated with the plurality of vehicle components or performance of the vehicle based on the at least one identified and recommended inspection task, where the at least one identified and recommended inspection task includes an identified and recommended driving test of a particular sequence.

In some examples, the smart mobile computing device in an established connection with the OBD of the vehicle may be configured to perform the identified and recommended RPM test by manually or remotely varying a throttle to preset RPMs and in order to consistently collect relevant OBD data from the vehicle.

In some examples, the smart mobile computing device in an established connection with the OBD of the vehicle may be configured to perform mobile emission and regulatory tests on the vehicle.

In some examples, the server may be configured to assign dynamically an inspector based on a plurality of parameters comprising proximity to the vehicle, experience with vehicle types, and training of the inspector.

In some examples, a machine learning module of the system may train itself and learn from the obtained parameters, vehicle history, and all other vehicle information, and generate at least one correlation model based on at least one of the obtained at least one parameter associated with the vehicle, at least one generated profile of the vehicle, the at least one identified and recommended inspection task, and at least one received input associated with inspection data.

In some examples, the server may be configured to determine a health score of the vehicle using at least one machine learning (ML) technique or at least one artificial intelligence (AI) technique pre-configured in the smart mobile computing device, the at least one ML technique or the at least one AI technique utilizing at least one of the obtained parameters associated with the vehicle, at least one generated profile of the vehicle, the at least one identified and recommended inspection task, and at least one received input associated with inspection data for determining a health score of the vehicle.

In some examples, the health score may be indicative of at least one of a monetary value, maintenance cost or a predictive remainder life associated with the vehicle.

In some examples, the server may be configured to connect with at least one historical information source to obtain historical data of the vehicle, the at least one historical information source comprising a database server having historical information of at least one vehicle information, where a detection of a change in the VIN from the database server results in a determination of an alteration or fraud related to the vehicle.

In another embodiment, a method for generating a dynamic and customized inspection checklist for diagnosing a vehicle using a smart mobile computing device is provided in accordance with the present disclosure. The method may include determining a vehicle identification number (VIN) of the vehicle; generate a dynamic inspection checklist customized based on the obtained at least one parameter, the customized dynamic inspection checklist including at least one identified and recommended inspection task for an inspector; connecting with at least one sensor associated with a plurality of vehicle components installed on the vehicle to obtain, in real-time, at least one parameter associated with each of the plurality of vehicle components; generating a dynamic inspection checklist customized based on the obtained at least one parameter associated with the vehicle, the customized inspection checklist including at least one identified and recommended inspection task for an inspector; and retrieving, at least in response to establishing a connection with at least one of an on-board diagnostics (OBD) of the vehicle or the at least one sensor, the obtained at least one parameters associated with each of a plurality of vehicle components installed on the vehicle.

In some examples, the method may further include retrieving historical information of the vehicle based on the VIN.

In some examples, the method may further include determining the VIN by scanning a door frame or a windshield or by connecting to the OBD of the vehicle.

In some examples, obtaining the model of the vehicle comprises manually inputting, by the inspector, a model information of the vehicle into the smart mobile computing device, the model information comprising a model number and a model year.

In some examples, obtaining the make of the vehicle comprises manually inputting, by the inspector, a make information of the vehicle into the smart mobile computing device, the make information comprising a brand name of vehicle manufacturer.

In some examples, the method may further include guiding the inspector to perform a guided test sequentially recommended based on the dynamic inspection checklist.

In some examples, the method may further include receiving an input from the inspector during a guided inspection of the vehicle.

In some examples, the method may further include generating different types of labels based on at least one pre-determined label to receive inputs from the inspector.

In some examples, the method may further include generating at least one profile of the vehicle based on at least one input associated with inspection data received in response to a user interface presented in accordance with the dynamic inspection checklist.

In some examples, the method may further include receiving at least one input associated with inspection data via an input device of the smart mobile computing device in response to a user interface presented in accordance with the dynamic inspection checklist.

In some examples, the method may further include performing the at least one identified and recommended inspection task and display at least one label to receive facts associated with a plurality of vehicle components or performance of the vehicle based on the at least one identified and recommended task.

In some examples, the method may further include generating at least one report based on at least one of the obtained parameter associated with the vehicle, the at least one generated profile of the vehicle, the at least one identified and recommended inspection task, and at least one received input associated with inspection data; or generating at least one correlation model based on at least one of the obtained parameter associated with the vehicle, the at least one generated profile of the vehicle, the at least one identified and recommended inspection task, and at least one received input associated with inspection data.

In some examples, generating the at least one correlation model may include training a machine learning module of the system to learn based on the obtained parameters, the at least one generated profile of the vehicle, and all other vehicle information received, and may generate the at least one correlation model based on at least one of the obtained parameters, the at least one generated profile of the vehicle, the at least one identified and recommended inspection task, and the at least one received input associated with the inspection data.

The summary of the invention does not necessarily disclose all the features essential for defining the invention. The invention may reside in a sub-combination of the disclosed features. The various combination and sub-combination are fully described in the detailed description.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 is a schematic diagram of an example inspection system for generating a dynamic and customized inspection checklist for diagnosing a vehicle in accordance with the present disclosure;

FIG. 2 is a block diagram of a smart mobile computing device in accordance with the present disclosure;

FIG. 3 illustrates a block diagram showing example steps of overall operations of the inspection system in accordance with the present disclosure;

FIG. 4 is a composite view of an example vehicle in accordance with the present disclosure;

FIGS. 5A-C illustrate example mobile app interfaces showing panel images of the vehicle in accordance with the present disclosure;

FIGS. 6A-D illustrate various views of another example vehicle in accordance with the present disclosure;

FIGS. 7A-H illustrate example screens showing various tests and corresponding inputs in accordance with the present disclosure;

FIGS. 8A-L illustrate another example mobile application interfaces in accordance with the present disclosure; and

FIG. 9 is a flowchart for a method for generating a dynamic and customized inspection checklist for diagnosing a vehicle using a smart mobile computing device in accordance with the present disclosure.

### DETAILED DESCRIPTION OF DRAWINGS

As used herein, the statement that two or more parts or components are “coupled” shall mean that the parts are joined or operate together either directly or indirectly, i.e., through one or more intermediate part or components, so long as a link occurs.

As used herein, “directly coupled” means that two elements are directly in contact with each other.

As used herein, the term “number” shall mean one or an integer greater than one (i.e., a plurality).

As used herein, the terms “exterior inspection,” “exterior check,” or “exterior test” shall mean inspections, checks, or tests for, e.g., frame or structural damage due to collision, collision repairs that are below industry standards, significant dents, dings, and scratches, missing or broken components including glass and mirrors, operation of exterior lighting, abnormal wear and condition of tires (includes spare), providing documentation on tire size, brand and amount of tread remaining on each tire, significant damage to wheels and/or hubcaps.

As disclosed herein, the terms “interior inspection,” “interior check,” or “interior test” may mean inspections, checks, or tests for, e.g., providing documentation of all accessories, verifying proper operation of all factory equipment, significant damage to seats, carpets, headliner, sun visors, trim pieces, dash and console areas, missing or broken items, evidence of flood or water damage, etc.

As disclosed herein, the term “chassis” may include, but not limited to, damage or wear to exhaust system, steering system, shock absorbers, struts and CV boots transmission, differential or power steering leaks evidence of frame or structural damage due to collision, etc.

As disclosed herein, the term “Engine parameters” may include, but not limited to, significant oil or coolant leaks, condition of fluids, belts and hoses for wear or need of replacement, serious mechanical problems indicated by abnormal noises, evidence of overheating, poor running condition or exhaust smoke, missing or damaged components, etc.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It will be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

As described in greater detail herein in connection with various particular embodiments, the disclosed concept provides smart mobile computing device guided and/or enabled systems, methods, techniques, services and user interfaces for generating a dynamic and customized inspection checklist for inspections of a vehicle.

The disclosed concept will now be described, for purposes of explanation, in connection with numerous specific details in order to provide a thorough understanding of the subject innovation. It will be evident, however, that the disclosed concept can be practiced without these specific details without departing from the spirit and scope of this innovation.

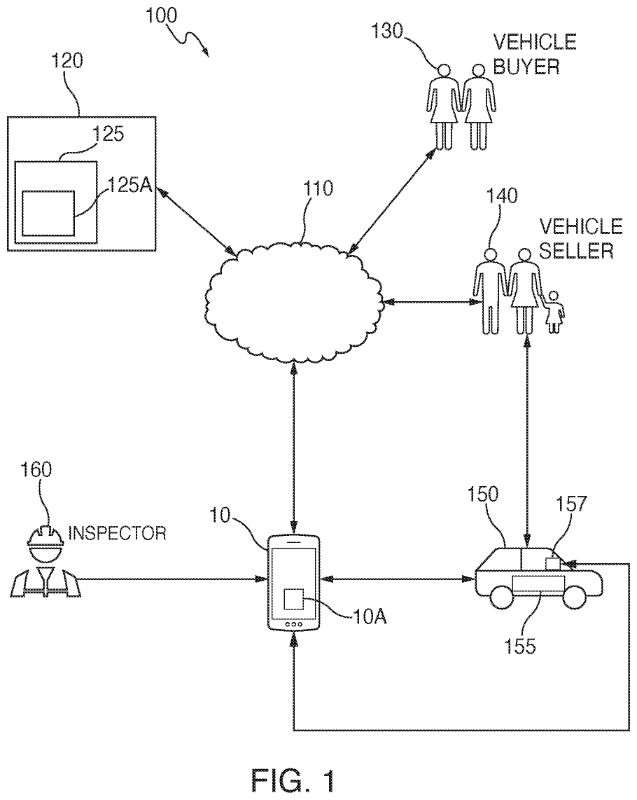

FIG. 1 is a schematic diagram of an example inspection system 100 for generating a dynamic and customized inspection checklist for diagnosing a vehicle in accordance with the present disclosure. In general, an inspection of a vehicle 150 is necessary for a vehicle seller 140 and a vehicle buyer 130 (e.g., so as to reduce any potential costs arising from disputes over the inspection, inspection results, inspection report, etc.). The interaction between the vehicle buyer 130 and the vehicle seller 140 may be done through the server 120. The inspection system 100 generally may operate by first receiving an order received for inspection of a vehicle 150. The order can be placed by a vehicle seller 140 or a vehicle buyer 130 or any intermediator or third party involved. Then, the vehicle seller 140 may confirm whether the vehicle 150 is available for inspection. Upon the confirmation, the server 120 may assign an inspector 160, who in turn performs the inspection on a slotted time period. First, the inspector 160 may scan the VIN using a mobile inspection application 10A running on the smart mobile computing device 10. Next, the smart mobile computing device 10 may upload the VIN to the server 120. Then, the server 120 may search in available vehicle historical databases or check for national registries, if access is permitted for vehicle information, to obtain vehicle history information of the vehicle 150. The server 120 may have a database of or have access to databases for vehicle history, vehicle manufacturers, insurance, police records, registration authorities and other external sources. Based on the vehicle information, the server 120 may generate a customized and/or dynamic inspection checklist and transmit the vehicle information to the mobile inspection app 10A running on the smart mobile computing device 10. Next, the inspector 160 may perform the inspection in accordance with the dynamic inspection checklist as guided by the mobile inspection app 10A. The guided vehicle inspection may direct the inspector 160 to perform guided tasks for inspection of a vehicle 150. The smart mobile computing device 10 may connect to on-board diagnostics (OBD) device 155 of the vehicle 150 via an OBD adapter 157, to retrieve the vehicle information from the server 120 and run tests real-time. The OBD device 155 may be a scanner installed within the vehicle 150 for scanning the OBD parameters of the vehicle 150 during the inspection. The smart mobile computing device 10 may connect to the OBD 155 via an OBD adapter 157 using wired or wireless technologies such as Bluetooth, WLAN, or short range communication technologies. The OBD adaptor 157 may be any type of adapter or interface (e.g., CarDr.com OBD adapter) that may translate OBD protocols (e.g., SAE J1850, ISO 9141, Keyword protocol 2000, etc.) into PC protocols (e.g., Bluetooth, WiFi, USB, RS232, etc.) or vice versa. The OBD adapter 157 may be coupled to the vehicle 150 via a cable or by directly being plugged or inserted into an electronic receptacle of the vehicle 150. Alternatively, the OBD adaptor 157 may be coupled to the vehicle 150 wirelessly. The smart mobile computing device 10, once connected to the OBD 155 of the vehicle 150 (e.g., upon turning ON the vehicle 150) may collect the vehicle information. The inspector 160 may submit the real-time information related to vehicle condition in the mobile inspection app 10A. The inspector 160 may need to submit the digital images of the vehicle components or panels or parts using the imaging device/camera of the smart mobile computing device 10, and submit the comments on the condition of the vehicle 150 to the mobile inspection app 10A.

Further detailed description of the inspection system 10 and the components and elements therein is provided below.

The system 100 may include a cloud network 110 via which a server 120, a vehicle buyer 130, a vehicle seller 140, a vehicle 150 including an OBD device 155, an OBD adapter or interface 157, and the inspector 160, the smart mobile computing device 10 and the mobile inspection app 10A may communicate with one another remotely and/or wirelessly. The server 120 may be a main or regional server for the inspection system 100, and include, among others, memory 125 for storing the vehicle information, the inspection results transmitted via the inspection device 10 or the mobile device 160, checklist based rules, damage valuation data, inspection schedules, inspection reports, other information relevant to data analytics and peer comparison, etc. The server 120 may include various software applications, firmware, and hardware programs, and updates for the operations of the inspection system 10. The software applications may include a software application 125A for generating a dynamic and customized inspection checklist for inspections of the vehicle 150 and providing a guided test or inspection sequentially recommended based on the dynamic inspection checklist. The software application 125A may include a machine learning (ML) module, neural network, and/or artificial intelligence (AI) based engine or module that may learn automatically and train themselves to understand types of tests required for different types of vehicles.

The server 120 may be configured to: generate a dynamic inspection checklist customized based on the obtained at least one parameter, the customized dynamic inspection checklist including at least one identified and recommended inspection task for the inspector 160; and retrieve, at least in response to establishing a connection with at least one of the OBD device 155 of the vehicle 150 or the at least one sensor, the obtained at least one parameter associated with each of the plurality of vehicle components installed on the vehicle 150. The OBD device 155 may provide error code detection and diagnostics during a test drive by the inspector 160. The at least one parameter may be obtained in real-time and include OBD parameters, including but not limited to, Engine parameters such as Engine load and Engine revolutions per minute (RPM), vehicle speed, a throttle position, coolant temperature, fuel trim, fuel pressure, fuel system status, intake manifold pressure, intake air temperature, mass air flow (MAF) air flow rate, air status, oxygen sensor status, runtime since engine start distance with a malfunction indicator lamp (MIL) on, fuel tank level input, system vapor pressure, absolute load, value, hybrid battery pack life, engine oil temperature, engine fuel rate, torque, VIN and various diagnostic trouble codes (DTCs). The dynamic inspection checklist may include the exterior checks (e.g., wiper blades, windshield washer, fog lights, etc.), interior checks (e.g., window switches, center console, dashboard, etc.), tires and wheels checks, and mechanical checks (e.g., transmission fluids, brake system, exhaust systems, etc.) of the vehicle 150. In some examples, the server 120 in data communication with the smart mobile computing device 10 may be configured to retrieve, at least in response to establishing connection with any or combination of the OBD, the at least one sensor, and the at least one historical information source, at least one of the year, make, and model, of the vehicle 150, at least one attribute associated with each of the plurality of vehicle components installed on the vehicle 150, and historical data of the vehicle 150; generate a customized inspection checklist based on the obtained data associated with the vehicle, the customized inspection checklist including at least one identified and recommended inspection task; and transmit the customized inspection checklist to the smart mobile computing device 10; and to present, on a user interface of the smart mobile computing device, using an output device, at least in part the customized inspection checklist.

In some examples, the server 120 may be configured to assign dynamically an inspector 160 based on a plurality of parameters including proximity to the vehicle, experience with vehicle types, and training of the inspector 160. In some examples, the server 120 may be configured to retrieve historical information of the vehicle 150 based on the vehicle identification number (VIN) transmitted by the smart mobile computing device 10 which scans the VIN on a windshield and/or a door frame of the vehicle 150. The server 120 may be configured to connect with at least one historical information source to obtain historical data of the vehicle 150, the at least one historical information source including a database server having historical information of at least one vehicle. Database servers having historical information may include database servers for vehicle history database companies (e.g., CarFax™, etc.), vehicle manufacturers, insurance companies, police, regulatory authorities (e.g., Division of Motor Vehicles), or other external sources. In some examples, the at least one historical information source may include a human inspector providing historical information of the vehicle information. In some examples, a detection of a change in the VIN from the database server results in a determination of an alteration or fraud related to the vehicle 150. In some examples, the server 120 may be configured to determine a health score of the vehicle 150 using at least one ML technique or at least one AI technique pre-configured in the server 120, the at least one ML technique or the at least one AI technique utilizes at least one of the obtained parameters associated with the vehicle 150, at least one generated profile of the vehicle 150, the at least one identified and recommended inspection task, and at least one received input associated with inspection data for determining a health score of the vehicle 150. The health score may be indicative of at least one of a monetary value, maintenance cost or a predictive remainder life associated with the vehicle 150. In some examples, the server 120 may generate a comprehensive vehicle inspection report based at least in part on the guided inspection based on the dynamic inspection checklist, at least one identified and recommended inspection task performed by the inspector 150, and the inputs and/or comments from the inspector 150 throughout the guided inspection. In some examples, a machine learning module of the inspection system 100 may be configured to train itself and generate at least one correlation model based on at least one of the obtained at least one parameter associated with the vehicle 150, at least one generated profile of the vehicle 150, the at least one identified and recommended inspection task, and at least one received input associated with inspection data.

The vehicle buyer 130 may access a vehicle inspection company (e.g., CarDr.com) over online platform using, e.g., a desktop, a laptop, a tablet, a smartphone, etc. and search for a vehicle of interest for inspection. Upon finding the vehicle of interest, the vehicle buyer 130 may indicate his/her interest in the vehicle or inquire whether the vehicle 150 is available for inspection. The vehicle seller 140 may then confirm whether the vehicle 150 is available for inspection. Upon confirmation of the inspection availability, the vehicle buyer 130, the vehicle seller 140 or any other third party of interest may place an order for inspection of the vehicle 150. Then, the server 120 may assign the inspector 160 who, in turn, performs the inspection of the vehicle 150 at a slotted time in accordance with the dynamic inspection checklist displayed on a user interface of the smart mobile computing device 10. The inspector 160 may inspect the external parts or components of the vehicle 150 as per the guided flow and as per the dynamic inspection checklist generated as per, e.g., the vehicle make/type/model and history. The inspector 160 may then inspect the internal parts or components of the vehicle 150 as per the guided flow and as per the dynamic checklist generated as per, e.g., the vehicle make/type/model and history. Next, the inspector 160 may inspect the mechanical parts of the vehicle 150 as per the guided flow and as per the dynamic checklist generated as per, e.g., the vehicle make/type/model and history. The facts or defects discovered during the inspection of external, internal and/or mechanical parts may be identified, and the identified facts or defects may be translated in the form of labelled data by the mobile inspection app 10A running on the smart mobile computing device 10. Inspection data during the external, internal, mechanical, and road tests as well as accessories may be uploaded to the server 120 as the inspector 160 performs these inspections with labeled images of the various parts and comments on the condition of the vehicle 160 in real-time. Next, the inspector 160 may supervise the overall inspection, provide feedback at the end of the inspection and verify the inspection in real-time.

The smart mobile computing device 10 may include the mobile inspection app 10A that may guide the inspector 160 in conducting the inspection in accordance with the present disclosure. The mobile inspection app 10A may be able to receive software, applications, program updates from the server 120 (e.g., the software application 125A) via the smart mobile computing device 10. For example, the mobile inspection app 10A may receive any updates and/or real-time training of the machine learning (ML) module, neural network, and/or artificial intelligence (AI) based engine or module of the software application 125. Alternatively, the mobile inspection app 10A may have its own ML module, neural network, and/or AI based engine or module. In some examples, the throttle may be moved robotically. In some examples, the mobile inspection app 10A may provide a graphical user interface (GUI) that is easy to use and guides the inspector 160 through the inspection process as per a dynamic inspection checklist. The guided process may mark the steps for the inspector 160 to perform inspection of parts, components, and sections of the vehicle 150 one-by-one and step-by-step. The GUI may be customized based on who the inspection is being performed for, the purpose of the inspection, and/or other factors.

In some examples, the smart mobile computing device 10 may be configured to: identify a type of vehicle based at least in part on obtaining at least one of a vehicle identification number (VIN) of the vehicle 150, a model of the vehicle 150, or a make of the vehicle 150; and connect with at least one sensor associated with a plurality of vehicle components installed on the vehicle 150 to obtain, in real-time, at least one parameter associated with each of the plurality of vehicle components. The VIN may be obtained or determined by scanning a door frame or a windshield or by connecting to the OBD device 155 of the vehicle 150. The model of the vehicle 150 may be obtained by manually inputting, by the inspector 160, a model information of the vehicle 10 into the smart mobile computing device 10, the model information including a model number and a model year. The make of the vehicle 150 may be obtained by manually inputting, by the inspector 160, a make information of the vehicle 150 into the smart mobile computing device 10, the make information comprising a brand name of vehicle manufacturer.

In some examples, the smart mobile computing device 10 may include at least one input device, at least one output device, and a mobile inspection module, configured to connect with on-board diagnostic (OBD) device 155 of the vehicle 150 to obtain, in real-time, at least one of a year, make, and model of the vehicle 150. Examples of an input device may be a touch screen display, a microphone, a stylus, etc. Examples of an output device may be a display, a speaker, etc. A mobile inspection module may be a mobile inspection app 10A (e.g., CarDr.com APP), running on the smart mobile computing device 10. In some examples, the smart mobile computing device 10 may be configured to determine the VIN by scanning a door frame or windshield or by connecting to the OBD device 155. In some examples, the smart mobile computing device 10 may be configured to guide the inspector 160 to perform a guided test sequentially recommended based on the dynamic inspection checklist. In some examples, the smart mobile computing device 10 may be configured to receive at least one input associated with inspection data via the at least one input device in response to a user interface presented in accordance with the dynamic inspection checklist.

In some examples, the smart mobile computing device 10 may be configured to be connected to the OBD device 155 (e.g., by connecting to OBD adapter) of the vehicle 150, e.g., on powering on the vehicle 150. The smart mobile computing device 10 may need to connect to the OBD device 155 of the vehicle 150 to, e.g., obtain at least one OBD parameter during OBD tests. The OBD device 155 may be a scanner installed within the vehicle 150 for scanning the OBD parameters of the vehicle 150 during the inspection. The smart mobile computing device 10 may connect to the OBD 155 via an OBD adapter 157 using wired or wireless technologies such as Bluetooth, WLAN, or short range communication technologies. The OBD adaptor 157 may be any type of adapter or interface (e.g., CarDr.com OBD adapter) that may translate OBD protocols (e.g., SAE J1850, ISO 9141, Keyword protocol 2000, etc.) into PC protocols (e.g., Bluetooth, WiFi, USB, RS232, etc.) or vice versa. The OBD adapter 157 may be coupled to the vehicle 150 via a cable or by directly being plugged or inserted into an electronic receptacle of the vehicle 150. Alternatively, the OBD adaptor 157 may be coupled to the vehicle 150 wirelessly. The smart mobile computing device 10 may collect the vehicle information (e.g., the at least one OBD parameter, etc.) and perform tests in real-time. Upon connecting to the OBD device 155, the smart mobile computing device 10 may perform OBD based tests, read OBD and RPM monitors. The OBD data and inspection data may then be uploaded to the server 120 by the smart mobile computing device 10. The server 120 may provide AI/server feedback, e.g., feedback generated by AI techniques preconfigured in the server 120 in real-time based on the input of the inspector 160. The inspector 160 may review the inspection based on the feedback of the server 120. The server 120 then may generate an inspection report, which may have at least labeled data, inspection facts, and historical and OBD data.

The smart mobile computing device 10 in an established connection with the OBD device 155 may be configured to perform the at least one identified and recommended inspection task and display at least one label to receive facts associated with a plurality of components or performance of the vehicle 150 based on the at least one identified and recommended inspection task, where the at least one identified and recommended inspection task may include an identified and recommended revolutions per minute (RPM) test(s). In some examples, the smart mobile computing device 10 may be configured to perform the identified and recommended RPM test(s) by manually or remotely varying a throttle to preset RPMs and collect relevant OBD data from the vehicle 150. For example, the RPM tests may be performed in a particular sequence: (1) press the throttle until the RPM reaches 1,500 RPMs; and (2) press the throttle until the RPM reaches 2,500 RPMs, collecting the OBD data during each test. In some examples, the throttle may be moved robotically. In some examples, a driving test may be performed in a particular sequence as well. For example, the inspector 160 may (1) drive the vehicle 150 for two minutes at 25 miles per hour (mph); and (2) drive for two minutes at 45 mph, collecting the OBD data at each drive. In some examples, the driving test may also include collecting the OBD data while the vehicle remains idle for, e.g., two minutes. By performing RPM tests and/or driving tests at such sequences allow even more comprehensive OBD data to be obtained. In some examples, the smart mobile computing device 10, in an established connection with the OBD device 155 of the vehicle 150, may be configured to perform mobile emission and regulatory tests on the vehicle 150. In some examples, when the inspector 160 is finished with the inspection, the smart mobile computing device 10 may validate the inputted information for internal consistency and/or compliance with rules. For example, the smart mobile computing device 10 may warn the inspector 160 that he or she has forgotten to include certain information or has entered it incorrectly. Such inspection validation procedures may save time (e.g., when the inspector 160 may not have time to return to re-inspect the vehicle 150) and/or ensure that a more complete, reliable and accurate information is provided with respect to the vehicle 150.

Accordingly, the inspection system 100 in accordance with the present disclosure may provide a comprehensive inspection and report covering all relevant aspects of the vehicle 150, including a vehicle summary and fraud check, vehicle health score based on the comprehensive inspection, OBD metrics, exterior inspection, interior inspection, mechanical inspection, driving-road-test feedback, historical summary of the vehicle 150, vehicle Peer value, etc. Further, the inspection system 100 in accordance with the present disclosure may provide an unprecedented ease of use for non-computer expert inspectors 160 in performing the guided inspection. Additionally, the inspection system 100 in accordance with the present disclosure may prevent inspectors 160 from accidentally entering damages on parts that do not warrant such damages in the context of a given vehicle style or type. For example, the inspector 160 may be prevented from accidentally inputting a damage record for a pickup tailgate while inspecting a four-door sedan.

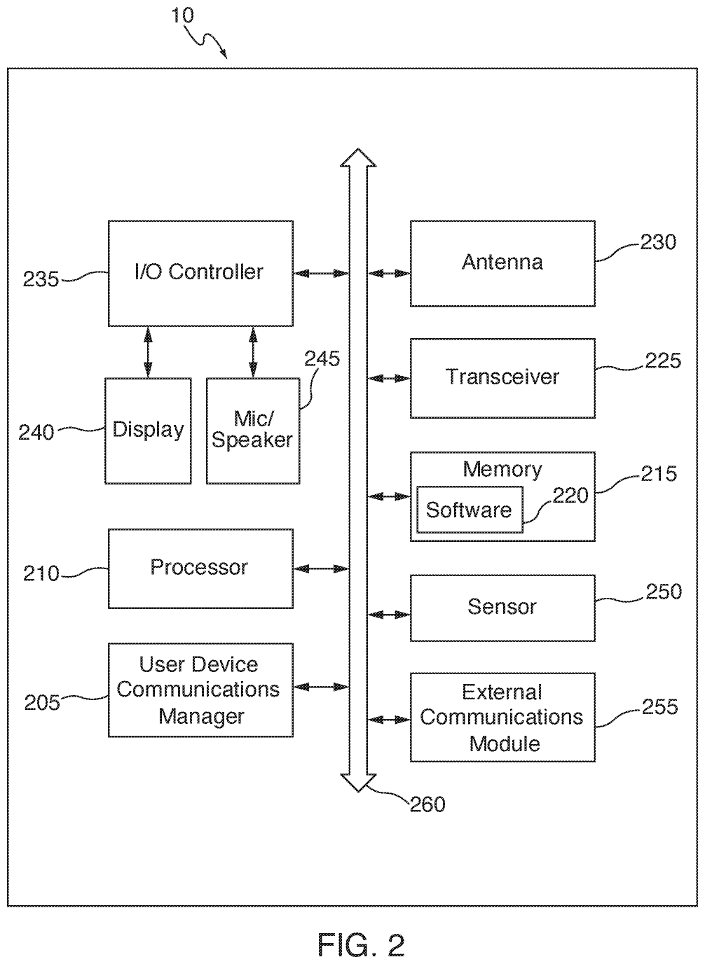

FIG. 2 is a block diagram of a smart mobile computing device 10 in accordance with the present disclosure. The smart mobile computing device 10 may include, but not limited to, any mobile user devices, for example, a cellular phone, a personal digital assistant (PDA), a wireless communication device, a tablet, a handheld device, or the like, that are capable of performing the previously stated operations and functionalities of the smart mobile computing device 10. The smart mobile communicating device 10 may include, but not limited to, user device communications manager 205, processor 210, memory 215, software 220, transceiver 225, antenna 230, I/O controller 235, display 240, audio devices 245 (e.g., a microphone, speaker, etc.), a sensor 250 (e.g., accelerometer, gyroscope, pressure sensor, thermal sensor, Hall-effect sensor, etc.), and an external communications module 255 (e.g., Application Programming Interface, etc.). These components may be in electronic communication via buses (e.g., bus 260). In some examples, the display 240 may include a touch screen that displays information for inspector 160 to see and allows the inspector 160 to input information textually, graphically, orally, etc., through input device or gestures and by other means. For example, the inspector 160 may use a stylus or a finger to actuate virtual buttons or links displayed on the touch screen, draw or otherwise indicate graphical information, or perform other data input operations.

The user device communications manager 205 or its components may be implemented in hardware, software executed by the processor 210, firmware, or any combination thereof. If implemented in software executed by the processor 210, the functions of the user device communications manager 205 may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform various functions, e.g., conveying information indicating parameters of communication layers, determining communication format (e.g., LTE, LTE-A, New Radio, etc.), generating messages in the determined format to communicate with the server 120, the OBD device 155 of the vehicle 150, etc., transmitting and receiving messages to and from the server 120, the OBD device 155 of the vehicle 150, and any other devices related to performing the functionalities of the smart mobile computing device 10.

The processor 210 may include an intelligent hardware device (e.g., a general-purpose processor, a DSP, a central processing unit (CPUI), a microcontroller, an ASIC, an FPGA, a programmable logic device, a discrete gate or transistor logic component, a discrete hardware component, or any combination thereof). The processor 210 may be configured to execute computer-readable instructions 220 stored in a memory 215 to perform various functions. The computer-readable instructions 220 may be implemented from an external software application server via external communications module 260.

The memory 215 may include random access memory (RAM) and read only memory (ROM). The memory 215 may store computer-readable, computer-executable software 220 including instructions, that when executed, cause the processor 210 to perform various functions described herein. In some examples, the memory 215 may store various different inspection rules and profiles and instructions for the processor 210 to use them to customize the process flow, dialogues and other aspects of the displayed or otherwise presented user interface to guide the inspector while performing inspection in real-time.

In some examples, the memory 215 may contain, among other things, a basic input/output system (BIOS) which may control basic hardware or software operation such as the interaction with peripheral components or devices.

The software 220 may include code or algorithm to implement aspects of the present disclosures. For example, the software 220 may include instructions (e.g., a mobile inspection app 10A for, e.g., providing a guided test or inspection sequentially recommended based on a dynamic inspection checklist in real-time) for the processor 210 to perform at least: implement (e.g., install) the mobile inspection app 10A upon a prompt by a user (e.g., an inspector 160) via external communication module 260; identify a type of vehicle based at least in part on obtaining at least one of a vehicle identification number (VIN) of the vehicle 150, a model of the vehicle 150, or a make of the vehicle 150; connect with at least one sensor associated with a plurality of vehicle components installed on the vehicle 150 to obtain, in real-time, at least one parameter associated with each of the plurality of vehicle components; determine the VIN by scanning a door frame or windshield or by connecting to the OBD device 155 of the vehicle 150; guide the inspector 160 to perform a guided test sequentially recommended based on the dynamic inspection checklist; receive at least one input from the inspector 160 while performing a guided inspection of the vehicle 150; receive at least one input associated with inspection data via the at least one input device in response to a user interface presented in accordance with the dynamic inspection checklist; perform the at least one identified and recommended inspection task and display at least one label to receive facts associated with a plurality of components or performance of the vehicle 150 based on the at least one identified and recommended inspection task, where the at least one identified and recommended inspection task may include an identified and recommended revolutions per minute (RPM) test; perform the identified and recommended RPM test by manually or robotically moving a throttle to achieve preset RPMs and collect relevant OBD data from the vehicle 150; perform mobile emission and regulatory tests on the vehicle 150, etc.

The software 220 may be stored in a non-transitory computer-readable medium such as system memory or other memory. In some cases, the software 220 may not be directly executable by the processor 210 but may cause a computer (e.g., when compiled and executed) to perform functions described herein. The memory 215 may also include firmware embedded for implementing the operations of the smart mobile computing device 10. Transceiver 225 may communicate bi-directionally, via one or more antennas 230, wired, or wireless links. For example, the transceiver 225 may represent a wireless transceiver and may communicate bi-directionally with another wireless transceiver. The smart mobile computing device 10 may include antennas 230, which may be capable of concurrently transmitting or receiving multiple wireless transmissions, e.g., from the server 120, the vehicle 150, the OBD 155 of the vehicles, etc. The I/O controller 240 may manage input and output signals for the smart mobile computing device 10. In some case, the I/O controller 240 may utilize an operation system such as iOS®, ANDROID®, MS-DOS®, MS-WINDOWS®, OS/2®, UNITX®, LINUX®, or other known operating system. In other cases, the I/O controller 240 may be implemented as part of a processor. In some cases, a user (e.g., an inspector 160) may interact with the smart mobile computing device 10 via I/O controller 240 or via hardware components controlled by I/O controller 240, for example, display 245 and audio device 250 (e.g., speaker, microphone, etc.).

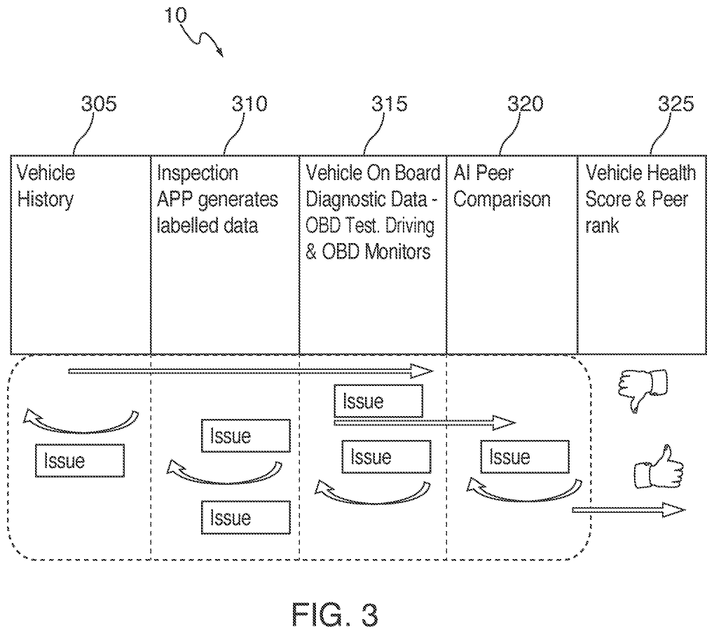

FIG. 3 illustrates a block diagram showing example steps 305-325 of the overall operations of the inspection system 100 in accordance with the present disclosure. At 305, the vehicle history may be collected by connecting to the OBD 155 of the vehicle 150 or by scanning the VIN on the windshield and on the door panels. At 310, a comprehensive guided inspection may be performed by an inspector 160 and all inputs related to the condition of the vehicle 150 in a guided manner are submitted by the inspector 160 in the mobile inspection app 10A running on the smart mobile computing device 10. At 315, OBD and error analytics may be performed by the smart mobile computing device 10 and the results are updated in real-time. At 320, the information recorded may be analyzed by an AI based system by the server 120 to compare the analyzed information with other peers. The AI based system may learn automatically based at least in part on the OBD parameters, vehicle history information, labeled data based on the inspection, driving test and RPM monitor data, and train the inspection system 10, particularly the server 120, to understand types of tests required for different types of vehicles. At 325, a vehicle health score and a peer rank of the vehicle 150 may be determined by the server 120. These steps are for illustrative purposes only, and thus, a person of ordinary skill in the art will understand that the steps are not limited to vehicle history information, labeled data based on the inspection, vehicle OBD data, driving test and RPM monitor data, AI based peer comparison and a final health score and peer rank. In some examples, a test may need to be reconducted on a particular part or component, if there is any issue with the test or the part. Thus, the inspection system 100 in accordance with the present disclosure requires the inspector 160 to perform the inspection completely and thoroughly.

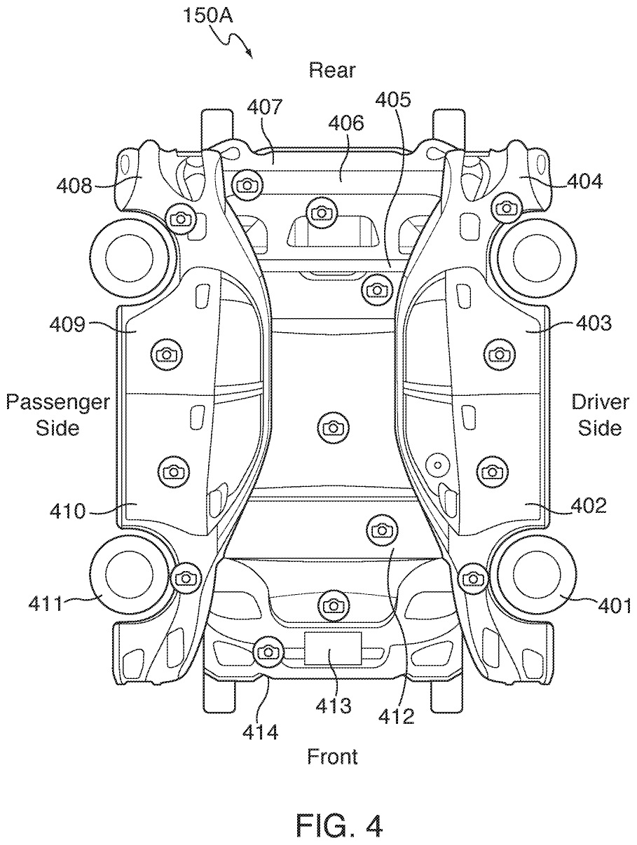

FIG. 4 is a composite view of an example vehicle 150A in accordance with the present disclosure. The vehicle 150A may be a passenger vehicle. In FIG. 4, the numbers 401-414 may denote guided inspection steps for the inspector 160 in accordance with a dynamic inspection list received from the server 120. These numbered steps are for illustrative purposes only, and thus the person of ordinary skill in the art will understand that the numbered steps may include different parts, components, sections of the vehicle 150A. The inspector 160 may inspect the vehicle 150A in a guided manner, where the inspector 160 takes the images of the physically or visually damaged interior and exterior parts of the vehicle 150A and submit those images to the mobile inspection app 10A running on the smart mobile computing device 10. The inspector 160 may use a digital camera or other imaging device to capture the images of the vehicle 140. Such a digital camera or other imaging device may be connected to or an integral part of the smart mobile computing device 10, which may then store in its memory such captured images along with other collected inspection information. In some examples, a printer may be used to print hard copies of inspection reports and other data.

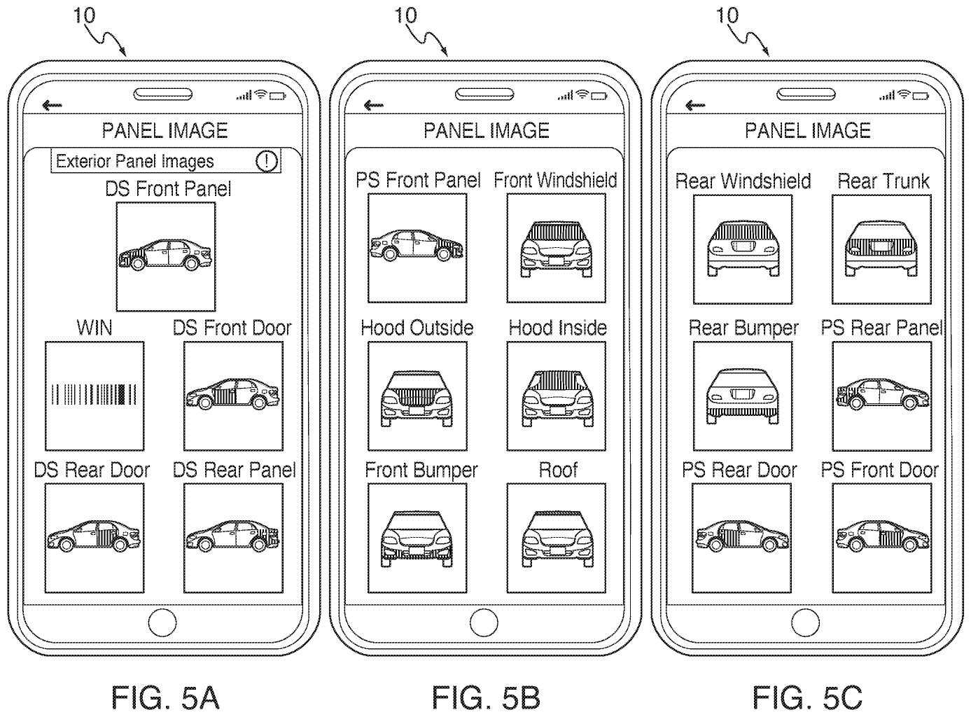

FIGS. 5A-C illustrate example mobile app interfaces showing panel images of the vehicle 150A in accordance with the present disclosure. FIG. 5A shows the panel images for driver side of the vehicle 150A in accordance with the present disclosure. FIG. 5B shows the panel images for some passenger side, front, and roof of the vehicle 150A in accordance with the present disclosure. FIG. 5C shows panels images for the rear and some passenger side of the vehicle 150A in accordance with the present disclosure. The panel images in FIGS. 5A-C are for illustrative purposes only, and thus the person of ordinary skill in the art will understand that these images may vary. In FIGS. 5A-C, the panel images may include various pictures of VIN, Front door, Side panel, Side doors Roof, Bumper, Hood outside, Hood Inside, Rear windshield, Tires, Mirrors and Seat covers and all other components. However, the panel images are not limiting to the images shown therein. In some examples, all exterior and interior components may be captured by a camera of the smart mobile computing device 10. The comments by the inspector 160 may be input into the mobile inspection app 10A.

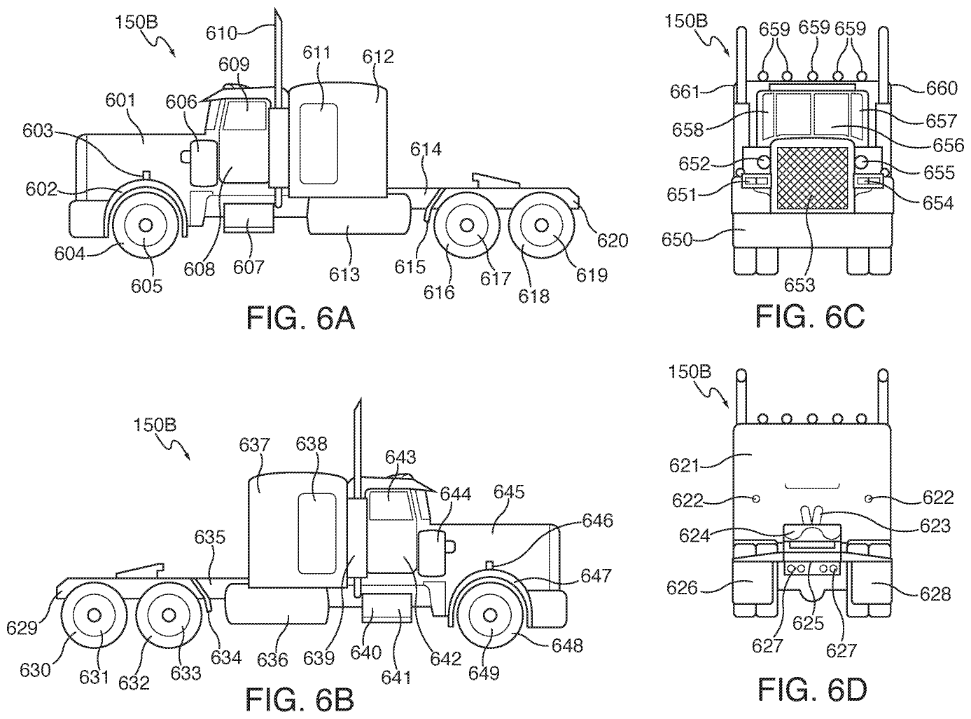

FIGS. 6A-D illustrate various views of another example vehicle, e.g., a semi-truck 150B in accordance with the present disclosure. FIG. 6A shows a driver side view of the semi-truck 150B in accordance with the present disclosure. FIG. 6B shows a passenger side view of the semi-truck 150B in accordance with the present disclosure. FIG. 6C shows a front view of the semi-truck 150B in accordance with the present disclosure. FIG. 6D shows a rear view of the semi-truck 150B in accordance with the present disclosure. These views include numbers 601-661 denoting guided inspection steps for the inspector 160 in accordance with a dynamic inspection list received from the server 120. These numbered steps are for illustrative purposes only, and thus the person of ordinary skill in the art will understand that these steps may vary. Further, these exterior and interior components to be inspected during the guided inspection are for illustrative purposes only and are not limiting. Thus, a guided inspection in accordance with the present disclosure may cover more than, e.g., 100, 200, 500, etc. tests for the inspection of the semi-truck 150B.

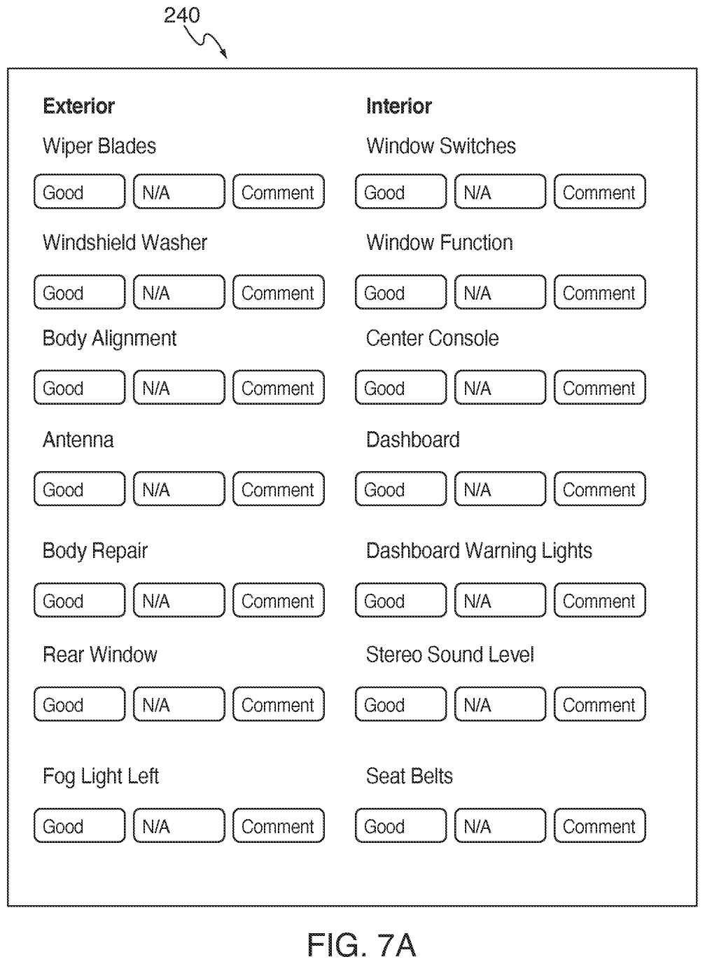

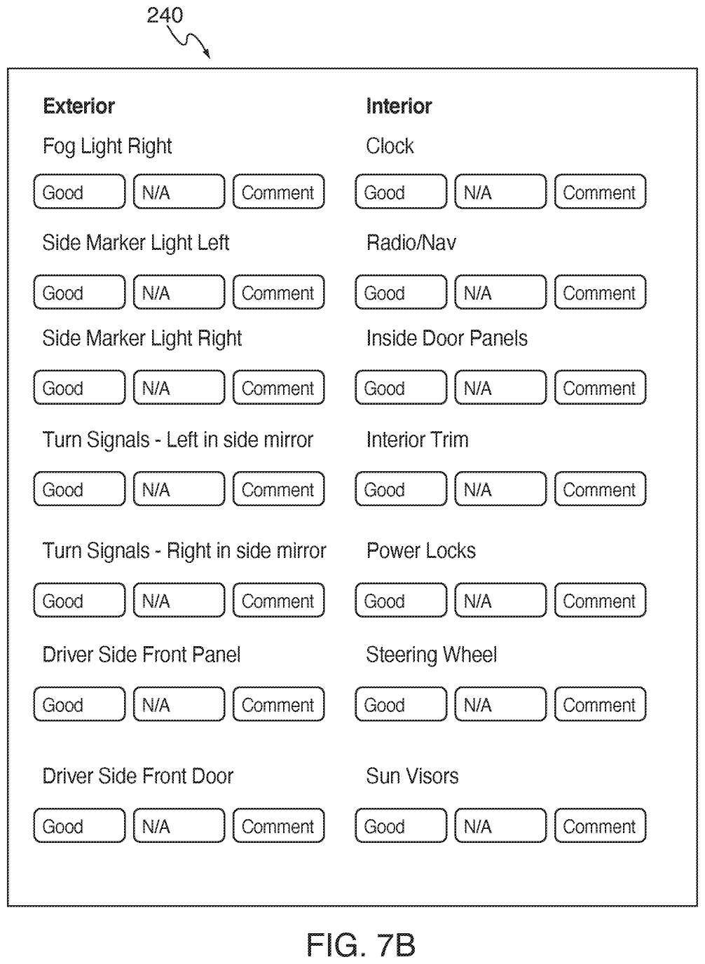

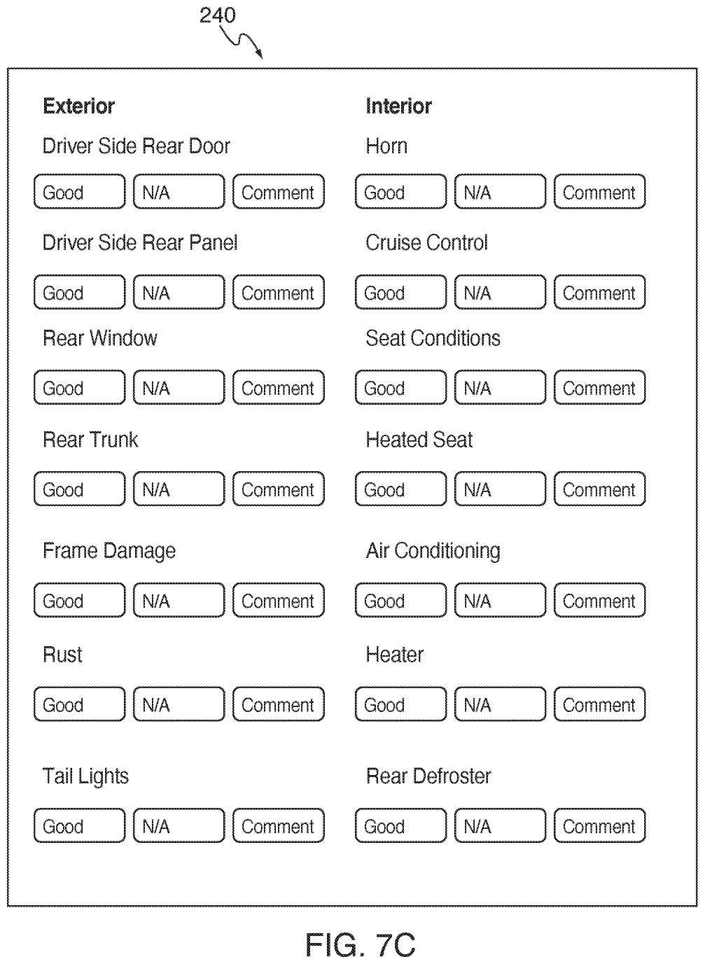

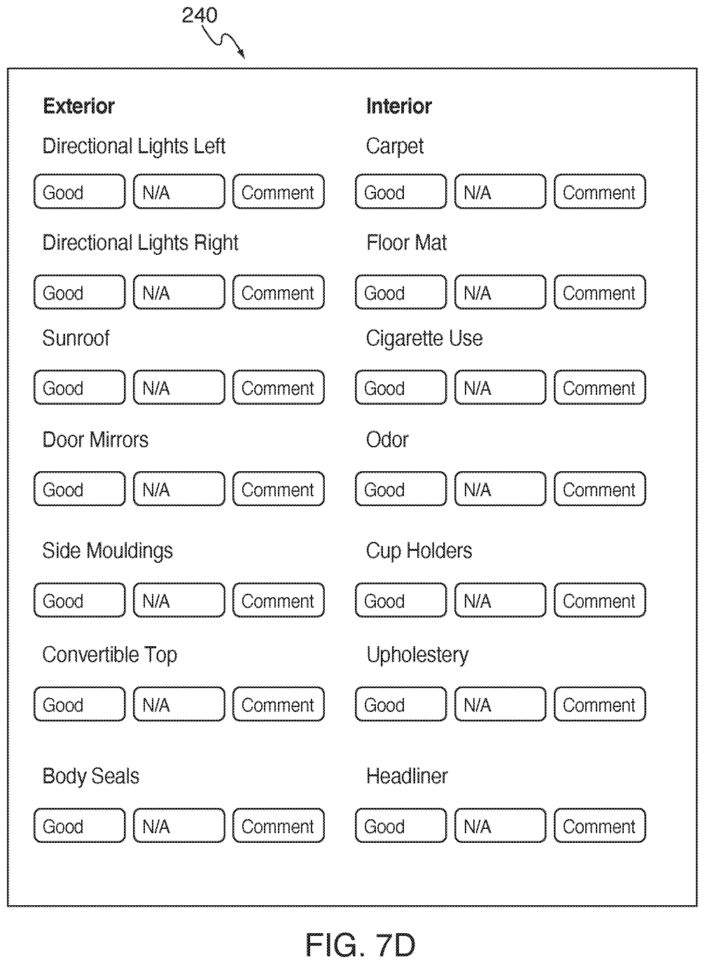

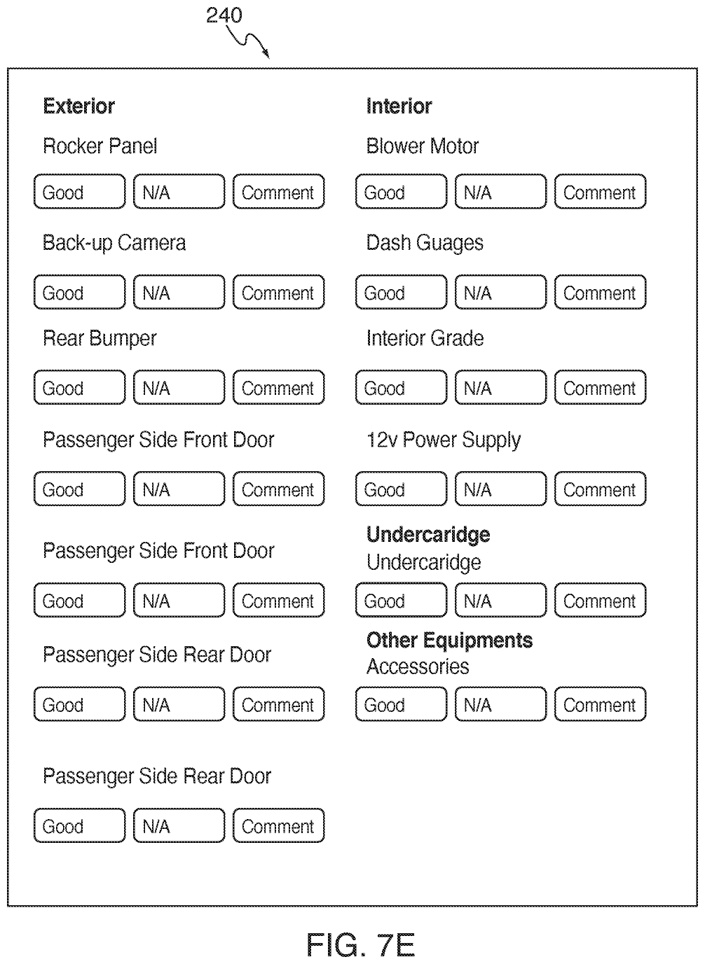

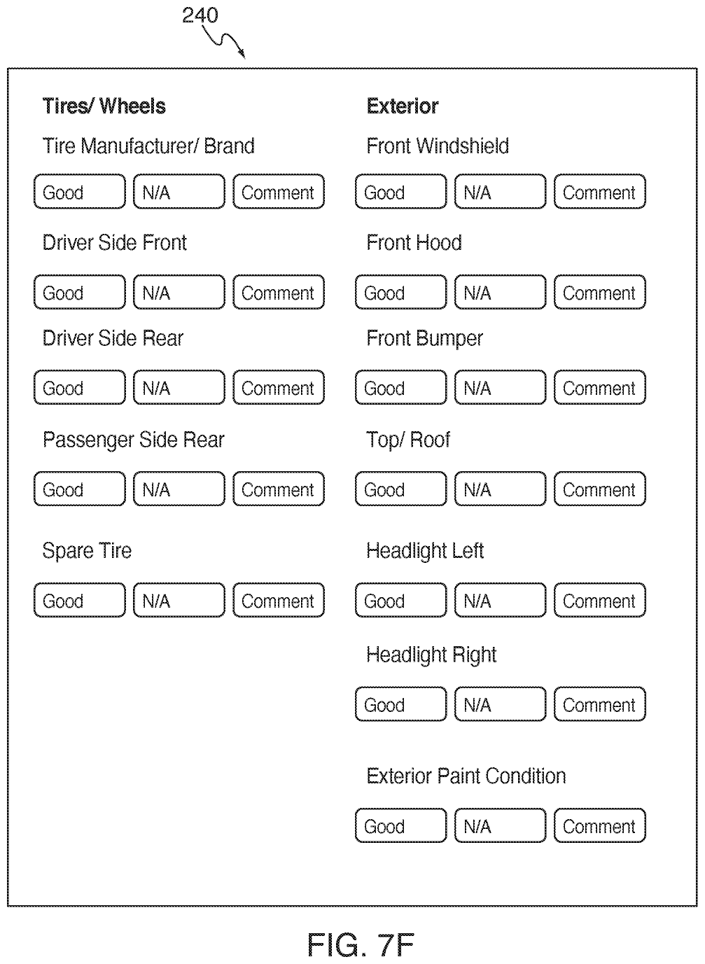

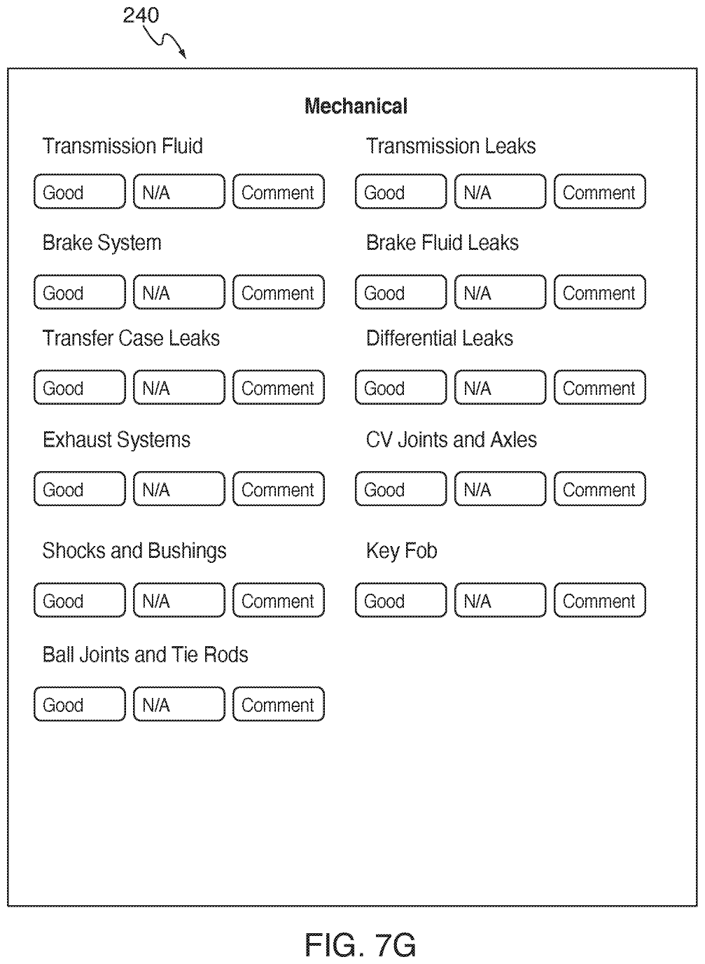

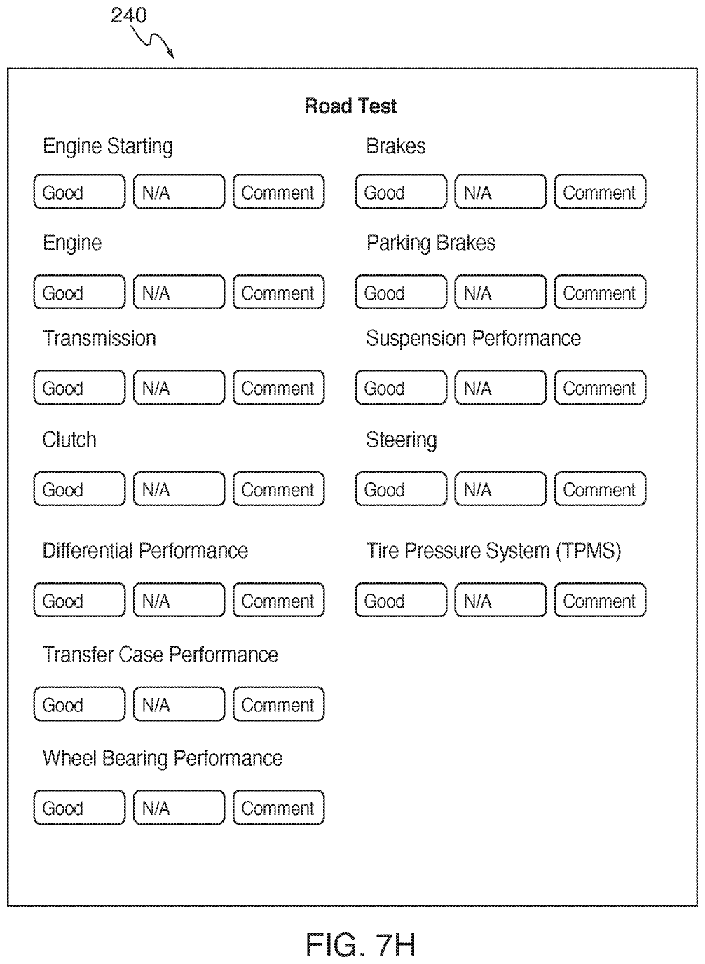

FIGS. 7A-H illustrate example screens of display 240 showing various labels for a guided inspection of the vehicle 150B and corresponding inputs in accordance with the present disclosure. The smart mobile computing device 10 may generate different types of labels based on at least one pre-determined label to receive inputs from the inspector 160. The labels shown in FIGS. 7A-H are for illustrative purposes only, and thus are not limiting. The person of ordinary skill in the art will understand that the labels may vary and include different, more exhaustive, or more comprehensive labeled items for inspection, depending on a type, vehicle history, vehicle information, etc. of the vehicle being inspected. For example, there may be more than e.g., 100, 200, 500, etc. labeled items for inspection for a semi-truck having an extensive vehicle history, vehicle information, etc. The inputs may be entered to the mobile inspection app 10A running on the smart mobile computing device 10 by the inspector 160 during the guided inspection. In some examples, the smart mobile computing device 10 may generate at least one profile of the vehicle 150 based on at least one input associated with inspection data received in response to the labels presented in a user interface of the smart mobile computing device 10. A profile of the vehicle 150 may include all information relating to the VIN of the vehicle 150 and the vehicle itself, and thus the profiled is unique to the individual vehicle being inspected. For example, a profile of a 2008 Toyota Corolla™ having 2,200 miles on its odometer may be different from a profile of a 2008 Toyota Corolla™ having 100,000 miles its odometer.

In some examples, the smart mobile computing device (e.g., a wireless mobile phone or any other handheld computing device) 10 may call up pages from a web server 120 via an input device of the smart mobile computing device 10, allow the inspector 160 to ‘walk through’ the check-list steps 601-661 based on the pages, and provide prompts for the inspector 160 to enter data as shown in FIGS. 7A-H. In FIGS. 7A-H, the inspector 160 may comment on the conditions of the vehicle 150B in a section provided in the mobile inspection app 10A, e.g., on a user interface (e.g., touch screen) of the smart mobile computing device 10. Thus, the guided inspection may assist the inspector 160 in a step-by-step inspection without leaving any interior or exterior component of the vehicle 150 uninspected. Further, the real-time images or comments in the mobile inspection app 10A may render the inspection thorough and complete.

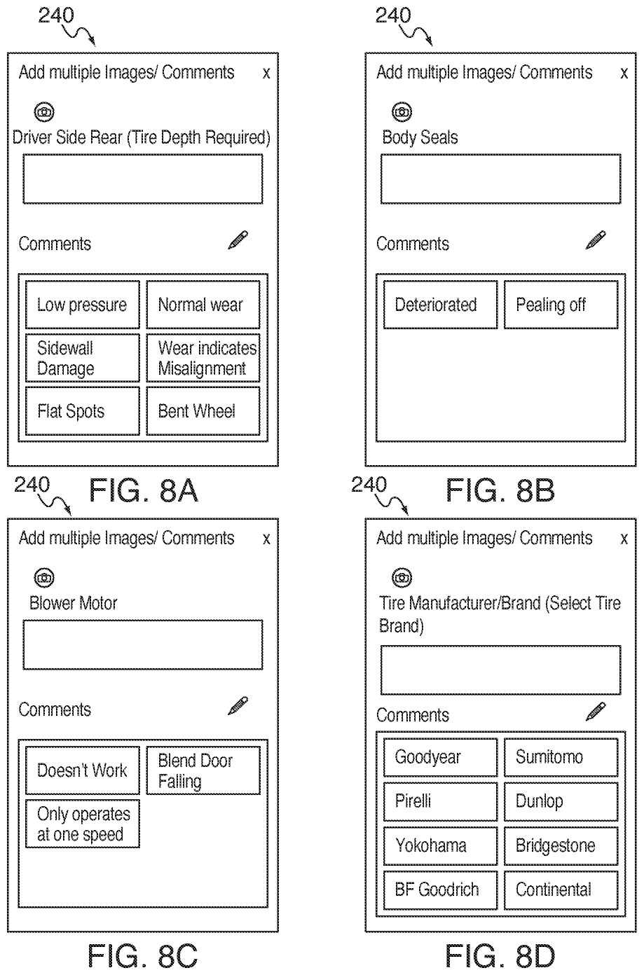

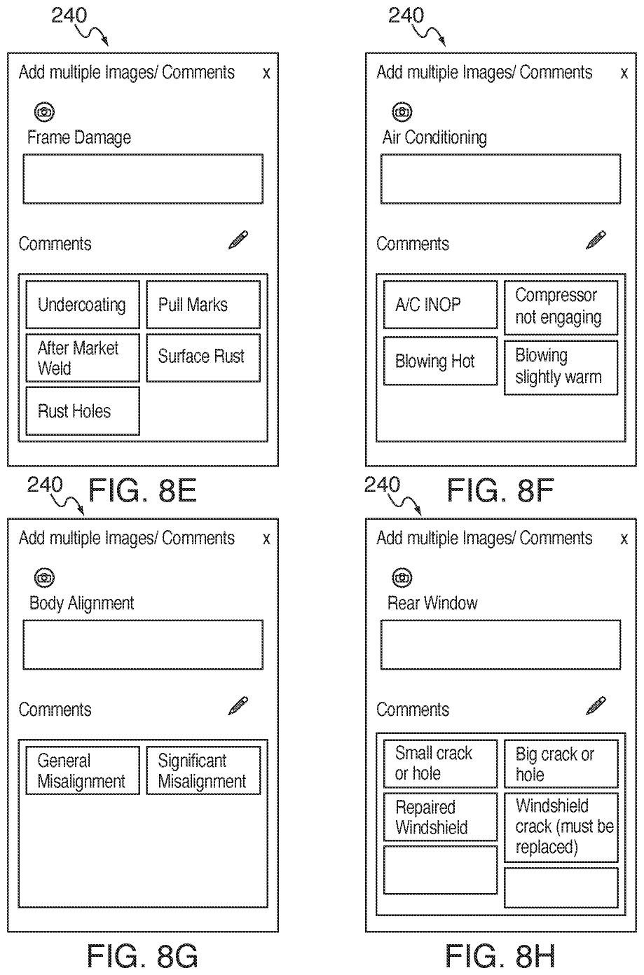

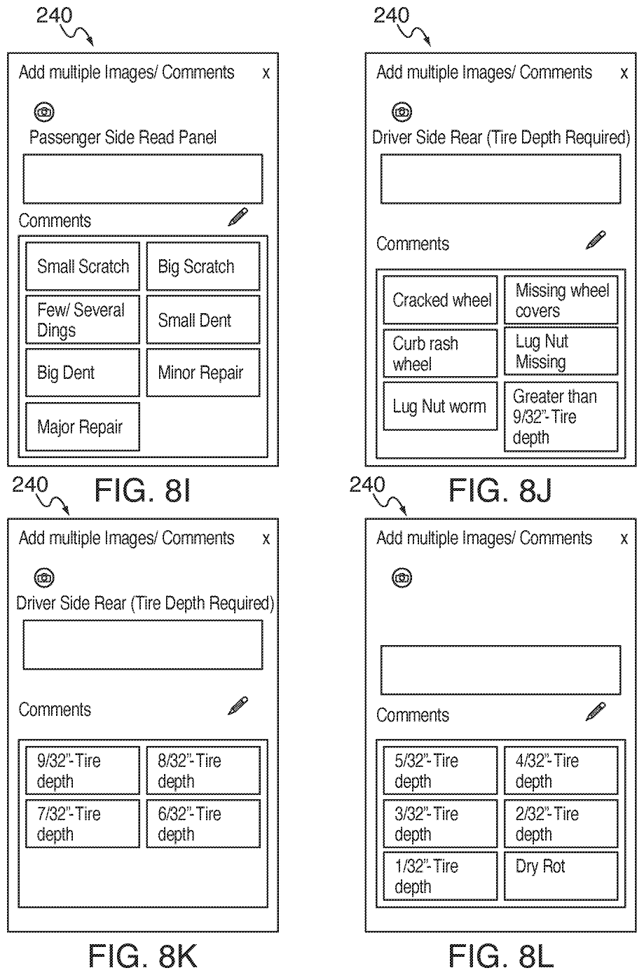

FIGS. 8A-L illustrate example mobile application interfaces (e.g., display 240) in accordance with the present disclosure. In FIGS. 8A-L show various labels for testing with more comments for the inspector 160 to enter or auto-populated to the mobile inspection app 10A running on the smart mobile computing device 10. The inspector 160 may input his/her comments and upload images of different components, parts, sections, etc., of a vehicle 150 under inspection. The comments may be auto-populated and vary for different vehicles based on a dynamic inspection checklist generated based on a type of the vehicle 150. In some examples, related comments for each component may be auto-populated. For example, while inspecting the tire of the vehicle 150, the mobile inspection app 10A may request the inspector 160 to input a brand, type, and condition of the tire. Further, the inspector 160 may have an option to put the comments manually along with an option to select auto-populated comments. In some examples, the mobile inspection app 10A may provide the inspector 160 an option to upload images as a proof of what inspector 160 may be seeing, commenting and recording real-time during the inspection.

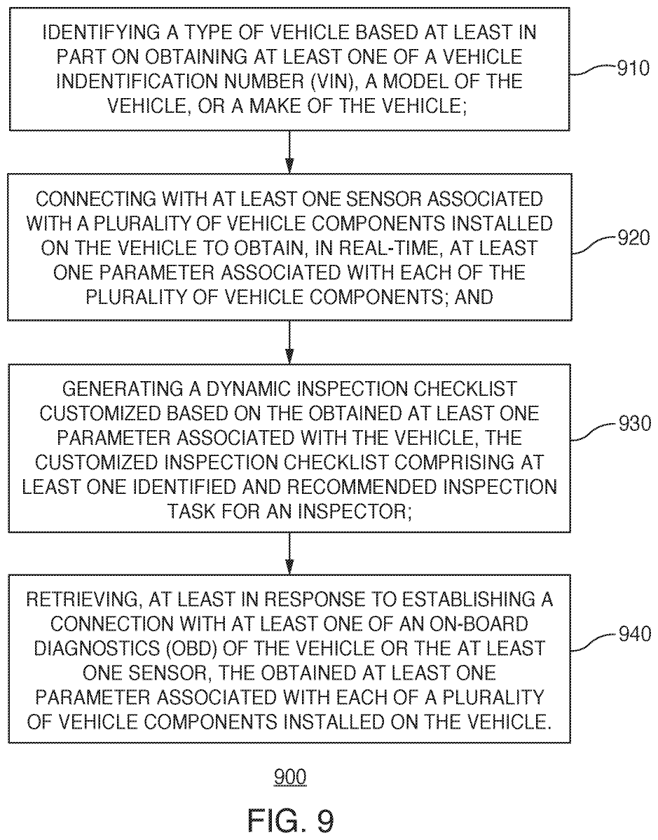

FIG. 9 is a flowchart for a method for generating a dynamic and customized inspection checklist for diagnosing a vehicle using a smart mobile computing device in accordance with the present disclosure. The method may be performed by the inspection system 10, and/or its components and elements therein (e.g., the server 120, the smart mobile computing device 10, inspector 160, etc.), as described with reference to FIG. 1.

At 910, the smart mobile computing device 10 may identify a type of vehicle based at least in part on obtaining at least one of a vehicle identification number (VIN) of the vehicle, a model of the vehicle, or a make of the vehicle. In some examples, determining the VIN may include determining VIN by scanning an image of a door frame or a windshield or by connecting to an on-board diagnostics (OBD) 155 of the vehicle 150. In some examples, obtaining the model of the vehicle may include manually inputting, by the inspector, a model information of the vehicle into the smart mobile computing device, the model information comprising a model number and a model year. In some examples, obtaining the make of the vehicle may include manually inputting, by the inspector, a make information of the vehicle into the smart mobile computing device, the make information comprising a brand name of vehicle manufacturer.

At 920, the smart mobile computing device 10 may connect with at least one sensor associated with a plurality of vehicle components installed on the vehicle to obtain, in real-time, at least one parameter associated with each of the plurality of vehicle components.

At 930, the server 120 may generate a dynamic inspection checklist customized based on the obtained at least one parameter associated with the vehicle, the customized inspection checklist comprising at least one identified and recommended inspection task for an inspector.

At 940, the server 120 may retrieve, at least in response to establishing a connection with at least one of an on-board diagnostics (OBD) of the vehicle or the at least one sensor, the obtained at least one parameter associated with each of a plurality of vehicle components installed on the vehicle.

In some examples, the smart mobile computing device 10 may guide the inspector 160 to perform a guided test sequentially recommended based on the dynamic inspection checklist. In some examples, the smart mobile computing device 10 may receive an input from the inspector 160 during a guided inspection of the vehicle 150. In some examples, the smart mobile computing device 10 may generate different types of labels based on at least one pre-determined label to receive input from the inspector 160. In some examples, the smart mobile computing device 10 may generate at least one profile of the vehicle 150 based on at least one input associated with inspection data received in response to a user interface presented in accordance with the dynamic inspection checklist. In some examples, the smart mobile computing device 10 may receive at least one input associated with inspection data via an input device of the smart mobile computing device 10 in response to a user interface presented in accordance with the dynamic inspection checklist. In some examples, the smart mobile computing device 10 or the inspector may perform the at least one identified and recommended inspection task. In some examples, the smart mobile computing device 10 may display at least one label to receive facts associated with the plurality of vehicle components or performance of the vehicle 150 based on the at least one identified and recommended inspection task. In some examples, the server 120 may generate at least one report based on at least one of the obtained parameter associated with the vehicle 150, the at least one generated profile, the at least one identified and recommended inspection task, and at least one received input associated with inspection data. In some examples, the server 120 may generate at least one correlation models based on at least one of the obtained parameter associated with the vehicle 150, the at least one generated profile of the vehicle, the at least one identified and recommended inspection task, and at least one received inputs associated with inspection data.

In some examples, an machine learning module (e.g., as a part of the software application 125 within the server 120) may train itself to learn or adapt to, e.g., the obtained parameters, the at least on generated profile of the vehicle 150, vehicle history, relevant vehicle information of the type of the vehicle etc., and may generate correlational models based on at least one of the obtained parameter, the at least one generated profile of the vehicle 150, the vehicle history, the at least one identified and recommended inspection task, and the at least one received input associated with the inspection data. In some examples, the server 120 may determine a health score for the vehicle 150 using at least one machine learning (ML) technique or using at least one AI technique pre-configured in the smart mobile computing device 10, the ML technique or the AI technique utilizes at least one of the obtained at least one parameter associated with the vehicle, at least one generated profile, the at least one identified and recommended inspection tasks, and at least one received input associated with inspection data for determining a health score of the vehicle, where the health score is indicative of at least one of a monetary value, maintenance cost, or a predictive remainder life associated with the vehicle. In some examples, the server 120 may connect with at least one historical information source to obtain historical data of the vehicle 150, the at least one historical information source including a database server having historical information of at least one vehicle information, where a detection of a change in the VIN from the database server results in a determination of an alteration or fraud related to the vehicle.

Communication between the components can be facilitated, for example, with a wireless local area network (LAN) infrastructure between the server 120 and a smart mobile computing device 10. A camera preferably also communicates with the server 120 via the wireless network, or it may communicate with the server 120 by transfer of images using a universal service bus (USB) cable. LAN workstations can recall the stored data, e.g., from the server 120, or data can be recalled on any networked PC and optionally on a remote computer, e.g., that of a customer, using in whole or in part an internet connection.

Exemplary hardware that can be used to implement the invention could be, for example, a smart mobile computing device 10, an input touch-screen, a multi-mega-pixel digital camera, etc. Alternatively, a server computer can be used as the image and data storage unit for the current invention. In yet another alternative, the server 120 may serve as a local storage unit that is interconnected to a publicly accessible internet server.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A system for generating a dynamic and customized inspection checklist for diagnosing a vehicle, the system comprising:
a smart mobile computing device, including at least one input device, at least one output device, and a mobile inspection module, configured to:
identify a type of vehicle based at least in part on obtaining at least one of a vehicle identification number (VIN) of the vehicle, a model of the vehicle, or a make of the vehicle; and
connect with at least one sensor associated with a plurality of vehicle components installed on the vehicle to obtain, in real-time, at least one parameter associated with each of the plurality of vehicle components; and
a server communicatively coupled to the smart mobile computing device, the server configured to:
generate a dynamic inspection checklist customized based on the obtained at least one parameter, the customized dynamic inspection checklist comprising at least one identified and recommended inspection task for an inspector; and
retrieve, at least in response to establishing a connection with at least one of an on-board diagnostics (OBD) of the vehicle or the at least one sensor, the obtained at least one parameter associated with each of the plurality of vehicle components installed on the vehicle.

2. The system of claim 1, wherein the server is configured to retrieve historical information of the vehicle based on the VIN.

3. The system of claim 1, wherein the smart mobile computing device is configured to obtain the VIN by scanning an image of a door frame or a windshield.

4. The system of claim 1, wherein the smart mobile computing device is configured to obtain the VIN by connecting to the OBD.

5. The system of claim 1, wherein the smart mobile computing device is configured to obtain the model of the vehicle by manually inputting a model information of the vehicle into the smart mobile computing device by the inspector, the model information comprising a model number and a model year of the vehicle.

6. The system of claim 1, wherein the smart mobile computing device is configured to obtain the make of the vehicle by manually inputting a make information of the vehicle into the smart mobile computing device by the inspector, the make information comprising a brand name of vehicle manufacture.

7. The system of claim 1, wherein the smart mobile computing device is configured to guide the inspector to perform a guided test sequentially recommended based on the dynamic inspection checklist.

8. The system of claim 1, wherein the smart mobile computing device is configured to receive at least one input from the inspector while performing a guided inspection of the vehicle.

9. The system of claim 1, wherein the server is configured to generate different types of labels based on at least one pre-determined label to receive at least one input provided by the inspector.

10. The system of claim 1, wherein the server is configured to generate at least one profile of the vehicle based on at least one input associated with inspection data received from the inspector in response to a user interface presented in accordance with the dynamic inspection checklist.

11. The system of claim 1, wherein the smart mobile computing device is configured to receive at least one input associated with inspection data via the at least one input device in response to a user interface presented in accordance with the dynamic inspection checklist.

12. The system of claim 1, wherein the smart mobile computing device, in an established connection with the OBD of the vehicle, is configured to perform the at least one identified and recommended inspection task and display at least one label to receive facts associated with the plurality of vehicle components or performance of the vehicle based on the at least one identified and recommended inspection task, wherein the at least one identified and recommended inspection task comprises an identified and recommended revolutions per minute (RPM) test.

13. The system of claim 11, wherein the smart mobile computing device in an established connection with the OBD of the vehicle is configured to perform the identified and recommended RPM test by manually or remotely varying a throttle to preset RPMs and collect relevant OBD data from the vehicle.

14. The system of claim 1, wherein the smart mobile computing device in an established connection with the OBD of the vehicle is configured to perform the at least one identified and recommended inspection task and display at least one label to receive facts associated with the plurality of vehicle components or performance of the vehicle based on the at least one identified and recommended inspection task, wherein the at least one identified and recommended inspection task comprises an identified and recommended driving test of a particular sequence.

15. The system of claim 1, wherein the smart mobile computing device, in an established connection with the OBD of the vehicle, is configured to perform mobile emission and regulatory tests on the vehicle.

16. The system of claim 1, wherein the server is configured to assigns dynamically an inspector based on a plurality of parameters comprising proximity to the vehicle, experience with vehicle types, and training of the inspector.

17. The system of claim 1, wherein a machine learning module of the system is configured to be trained and generate at least one correlation model based on at least one of the obtained at least one parameter associated with the vehicle, at least one generated profile, the at least one identified and recommended inspection task, and at least one received input associated with inspection data.

18. The system of claim 1, wherein the server is configured to determine a health score for the vehicle using at least one machine learning (ML) technique or at least one artificial intelligence (AI) technique pre-configured in the smart mobile computing device, the at least one ML technique or the at least one AI technique utilizes at least one of the obtained parameters associated with the vehicle, at least one generated profile of the vehicle, the at least one identified and recommended inspection tasks, and at least one received inputs associated with inspection data for determining the health score.

19. The system of claim 14, wherein the health score is indicative of at least one of a monetary value, maintenance cost or a predictive remainder life associated with the vehicle.

20. The system of claim 1, wherein the server is configured to connect with at least one historical information source to obtain historical data of the vehicle, the at least one historical information source comprising a database server having historical information of at least one vehicle information, wherein a detection of a change in the VIN from the database server results in a determination of an alteration or fraud related to the vehicle.

21. A method for generating a dynamic and customized inspection checklist for diagnosing a vehicle using a smart mobile computing device, the method comprising:
identifying a type of vehicle based at least in part on obtaining at least one of a vehicle identification number (VIN), a model of the vehicle, or a make of the vehicle;
connecting with at least one sensor associated with a plurality of vehicle components installed on the vehicle to obtain, in real-time, at least one parameter associated with each of the plurality of vehicle components; and
generating a dynamic inspection checklist customized based on the obtained at least one parameter associated with the vehicle, the customized inspection checklist comprising at least one identified and recommended inspection task for an inspector; and
retrieving, at least in response to establishing a connection with at least one of an on-board diagnostics (OBD) of the vehicle or the at least one sensor, the obtained at least one parameter associated with each of a plurality of vehicle components installed on the vehicle.

22. The method of claim 21, further comprising: retrieving historical information of the vehicle based on the VIN.

23. The method of claim 21, wherein obtaining the VIN comprises determining the VIN by scanning an image of a door frame or a windshield.

24. The method of claim 21, wherein obtaining the VIN comprises determining the VIN by connecting to the OBD.

25. The method of claim 21, wherein obtaining the model of the vehicle comprises manually inputting, by the inspector, a model information of the vehicle into the smart mobile computing device, the model information comprising a model number and a model year.

26. The method of claim 21, wherein obtaining the make of the vehicle comprises manually inputting, by the inspector, a make information of the vehicle into the smart mobile computing device, the make information comprising a brand name of vehicle manufacturer.

27. The method of claim 21, further comprising: guiding the inspector to perform a guided test sequentially recommended based on the dynamic inspection checklist.

28. The method of claim 21, further comprising: receiving an input from the inspector during a guided inspection of the vehicle.

29. The method of claim 21, further comprising: generating different types of labels based on at least one pre-determined label to receive inputs from the inspector.

30. The method of claim 21, further comprising: generating at least one profile of the vehicle based on at least one input associated with inspection data received in response to a user interface presented in accordance with the dynamic inspection checklist.

31. The method of claim 21, further comprising: receiving at least one input associated with inspection data via an input device of the smart mobile computing device in response to a user interface presented in accordance with the dynamic inspection checklist.

32. The method of claim 21, further comprising: performing the at least one identified and recommended inspection task and display at least one labels to receive facts associated with the plurality of vehicle components or performance of the vehicle based on the at least one identified and recommended inspection tasks.

33. The method of claim 21, further comprising:
generating at least one report based on at least one of the obtained parameters associated with the vehicle, the at least one generated profile, the at least one identified and recommended inspection task, and at least one received input associated with inspection data; or
generating at least one correlation model based on at least one of the obtained parameter associated with the vehicle, the at least one generated profile of the vehicle, the at least one identified and recommended inspection tasks, and at least one received input associated with inspection data.

34. The method of claim 33, wherein generating the at least one correlation models comprises training a machine learning module of an inspection system incorporating a server and the smart mobile computing device based at least in part on at least one of the obtained parameter or vehicle information of the identified type of the vehicle.

35. The method of claim 21, further comprising:
determining a health score for the vehicle using at least one machine learning (ML) technique or using at least one artificial intelligence (AI) technique pre-configured in the smart mobile computing device, the ML technique or the AI technique utilizes at least one of the obtained at least one parameter associated with the vehicle, at least one generated profile, the at least one identified and recommended inspection task, and at least one received input associated with inspection data for determining a health score of the vehicle, wherein the health score is indicative of at least one of a monetary value, maintenance cost, or a predictive remainder life associated with the vehicle.

36. The method of claim 21, further comprising: connecting with at least one historical information source to obtain historical data of the vehicle, the at least one historical information source comprising a database server having historical information of at least one vehicle information, wherein a detection of a change in the VIN from the database server results in a determination of an alteration or fraud related to the vehicle.
